(19) United States
(12) Patent Application Publication
(10) Pub. No.: US 2018/0170447 A1
(43) Pub. Date: Jun. 21, 2018

(54) VEHICLE SUBSTRUCTURE

(71) Applicant: TOYOTA JIDOSHA KABUSHIKI KAISHA, Toyota-shi (JP)

(72) Inventors: Masahiro Iida, Okazaki-shi (JP); Hiroharu Iizuka, Togo-cho (JP)

(73) Assignee: TOYOTA JIDOSHA KABUSHIKI KAISHA, Toyota-shi (JP)

(21) Appl. No.: 15/831,853

(22) Filed: Dec. 5, 2017

(30) Foreign Application Priority Data
Dec. 15, 2016 (JP) 2016-243492

(51) Int. Cl. B62D 25/20

(52) U.S. Cl. CPC B62D 25/2018

(57) ABSTRACT

A vehicle substructure includes an indoor reinforcement disposed on the opposite side of a floor panel from a front side member. The indoor reinforcement includes an upper wall portion facing the floor panel and extending in a front-rear direction of a vehicle, a pair of side wall portions extending downward from respective outer edges on both sides of the upper wall portion in a width direction of the vehicle, and a pair of flange portions extending outwards from respective lower edges of the side wall portions with lower surfaces of the flange portions fixed to an upper surface of the floor panel. The upper wall portion has flat plate-shaped flat portions and a ridge portion protruding from the flat portions toward an upper side of the vehicle or a lower side of the vehicle and extending in the front-rear direction of the vehicle.

### INCORPORATION BY REFERENCE

The disclosure of Japanese Patent Application No. 2016-243492 filed on Dec. 15, 2016 including the specification, drawings and abstract is incorporated herein by reference in its entirety.

### BACKGROUND

### 1. Technical Field

The disclosure relates to a vehicle substructure.

### 2. Description of Related Art

Japanese Unexamined Patent Application Publication No. 2016-22816 (JP 2016-22816 A) discloses a vehicle substructure that is provided with a front side member which extends in the front-rear direction of a vehicle. The front side member is provided with a plate-shaped lower wall portion extending in the front-rear direction of the vehicle, side wall portions extending upward from respective outer edges of the lower wall portion in the width direction of the vehicle, and flange portions extending outwards from upper edges of the side wall portions. The lower surface of a plate-shaped floor panel that constitutes the floor surface of the vehicle is fixed to the upper surface of each flange portion of the front side member. The vehicle substructure disclosed in JP 2016-22816 A is also provided with an indoor reinforcement fixed to the upper surface of the floor panel. The indoor reinforcement is provided with a plate-shaped upper wall portion extending in the front-rear direction of the vehicle, side wall portions extending downward from respective outer edges of the upper wall portion in the width direction of the vehicle, and flange portions extending outwards from lower edges of the side wall portions. The lower surface of each flange portion of the indoor reinforcement is fixed to the upper surface of the floor panel.

### SUMMARY

When a load acts on the vehicle substructure disclosed in JP 2016-22816 A from the front of the vehicle, for example, a part of the load may act on the indoor reinforcement as well. It can be said that the shape of the indoor reinforcement of the vehicle substructure disclosed in JP 2016-22816 A is not suitable for effectively bearing the load nonetheless. Accordingly, the vehicle substructure disclosed in JP 2016-22816 A still has room for improvement.

An aspect relates to a vehicle substructure including a floor panel, a front side member disposed below the floor panel and extending in a front-rear direction of a vehicle, and an indoor reinforcement disposed above the floor panel and extending in the front-rear direction of the vehicle. The indoor reinforcement is disposed on the opposite side of the floor panel to the front side member. The indoor reinforcement includes an upper wall portion facing the floor panel and extending in the front-rear direction of the vehicle, a pair of side wall portions extending downward from respective outer edges on both sides of the upper wall portion in a width direction of the vehicle, and a pair of flange portions extending outwards from lower edges of respective side wall portions. Lower surfaces of the flange portions are fixed to an upper surface of the floor panel. The upper wall portion has flat plate-shaped flat portions and a ridge portion protruding from the flat portions toward an upper side of the vehicle or a lower side of the vehicle and extending in the front-rear direction of the vehicle.

According to the aspect, the upper wall portion of the indoor reinforcement is provided with the ridge portion, and thus a ridgeline extending in the front-rear direction of the vehicle is formed in the upper wall portion of the indoor reinforcement. As a result, the indoor reinforcement is less likely to be deformed by a force from the front-rear direction of the vehicle than in a case where merely a flat portion constitutes the upper wall portion without the ridge portion being disposed. Accordingly, when a load is given from the front of the vehicle, for example, the indoor reinforcement can effectively receive the load.

In the vehicle substructure according to the aspect, the upper wall portion may include the ridge portion positioned in a middle portion of the upper wall portion in the width direction of the vehicle and the flat portions positioned on both sides of the ridge portion in the width direction of the vehicle. The dimension of the ridge portion in the width direction of the vehicle may range from one-third to two-thirds of the dimension of the upper wall portion as a whole in the width direction of the vehicle.

According to the aspect, the entire upper wall portion of the indoor reinforcement is likely to be kept within a certain range in the width direction of the vehicle from the ridgeline as a boundary line between the ridge portion and the flat portion. Generally, in plate materials, flexural rigidity with respect to a load in the direction of the ridgeline is increasingly improved as the part that is within a certain range from the ridgeline increases. Accordingly, with the configuration described above, flexural rigidity with respect to a load in the front-rear direction of the vehicle is likely to be ensured even without an excessive increase in the plate thickness of the upper wall portion or the like.

In the vehicle substructure according to the aspect, the front side member may include a plate-shaped lower wall portion facing the floor panel and extending in the front-rear direction of the vehicle, a pair of side wall portions extending upward from respective outer edges of the lower wall portion in the width direction of the vehicle, and a pair of flange portions extending outwards from upper edges of respective side wall portions. Upper surfaces of the flange portions are fixed to a lower surface of the floor panel. The indoor reinforcement and the front side member may be formed of the same material to have the same plate thickness, and a distance from the upper surface of the floor panel to an upper surface of the flat portion of the indoor reinforcement may be equal to or longer than a distance from the lower surface of the floor panel to a lower surface of the lower wall portion of the front side member at at least a part the indoor reinforcement and the front side member in the front-rear direction of the vehicle.

According to the aspect, the indoor reinforcement is disposed above the floor panel and is relatively less likely to deteriorate over time as a result of wind, rain, and so on. The front side member is disposed below the floor panel and is relatively more likely to deteriorate over time as a result of wind, rain, and so on. In addition, the front side member is relatively more likely to undergo a decline in strength even after a surface treatment for preventing the deterioration. With the configuration described above, the indoor reinforcement that is relatively less likely to deteriorate accounts for at least half of the dimension of the vehicle substructure as a whole in the up-down direction of the vehicle, and thus a decline in the strength of the vehicle substructure as a whole is minimized even when the front side member is subjected to deterioration or the like.

In the vehicle substructure according to the aspect, the front side member may include a side member body portion and a side member front portion disposed ahead of the side member body portion in the front-rear direction of the vehicle and inclined such that a position of the side member front portion becomes closer to an upper side as the position of the side member front portion becomes closer to a front side of the vehicle. The floor panel may include a panel body portion and a panel front portion disposed ahead of the panel body portion in the front-rear direction of the vehicle and inclined such that a position of the panel front portion becomes closer to the upper side as the position of the panel front portion becomes closer to the front side of the vehicle. The indoor reinforcement may include a reinforcement body portion and a reinforcement front portion disposed ahead of the reinforcement body portion in the front-rear direction of the vehicle and inclined such that a position of the reinforcement front portion becomes closer to the upper side as the position of the reinforcement front portion becomes closer to the front side of the vehicle. A kick portion may be configured to include the side member front portion, the panel front portion, and the reinforcement front portion. The upper wall portion, the side wall portions, and the flange portions of the indoor reinforcement may be disposed in at least the reinforcement front portion.

According to the aspect, a power unit such as an internal combustion engine is disposed in front of the kick portion of the vehicle substructure. Accordingly, when sound insulation is insufficient in the kick portion, noise from the power unit may be transmitted into the vehicle cabin. When the above-described configurations related to the upper wall portion, the side wall portion, and the flange portion are applied to the reinforcement front portion of the indoor reinforcement as in the configuration described above, the panel front portion can be positioned on the obliquely lower front side of the vehicle compared to, for example, a case where the indoor reinforcement is configured to have a flat plate shape and a shape curved such that its middle portion in the vehicle protrudes downward. Accordingly, the distance from the panel front portion to the flooring material of the vehicle cabin above the panel front portion can be increased and the space therebetween is capable of functioning as a sound insulation space. As a result, noise transmission from the power unit into the vehicle cabin can be further suppressed.

In the vehicle substructure according to the aspect, the indoor reinforcement may be fixed to the floor panel such that a boundary between the reinforcement body portion and the reinforcement front portion corresponds to a boundary between the panel body portion and the panel front portion of the floor panel.

In the vehicle substructure according to the aspect, a front end of the reinforcement front portion of the indoor reinforcement may be positioned behind a front end of the panel front portion of the floor panel.

In the vehicle substructure according to the aspect, the front side member may be fixed to the floor panel such that a boundary between the side member body portion and the side member front portion corresponds to a boundary between the panel body portion and the panel front portion of the floor panel.

In the vehicle substructure according to the aspect, a length of the side wall portion from the lower wall portion constituting the side member front portion may increase toward the front side of the vehicle at a part of the side wall portion constituting the side member front portion of the front side member.

In the vehicle substructure according to the aspect, a front end side part of the side member front portion of the front side member may protrude more to the front side than a front portion of the panel front portion of the floor panel.

In the vehicle substructure according to the aspect, a length of the reinforcement body portion in the front-rear direction of the vehicle may be smaller than a length of the panel body portion of the floor panel in the front-rear direction of the vehicle.

In the vehicle substructure according to the aspect, a length of the reinforcement front portion in the front-rear direction of the vehicle may be smaller than a length of the panel front portion of the floor panel in the front-rear direction of the vehicle.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is an exploded perspective view of a vehicle substructure;

FIG. 2 is a side view of the vehicle substructure;

FIG. 3 is a cross-sectional view taken along line of FIG. 2; and

FIG. 4 is a sectional view for showing a part of the vehicle substructure contributing to flexural rigidity with respect to a load in a front-rear direction of a vehicle.

### DETAILED DESCRIPTION OF EMBODIMENTS

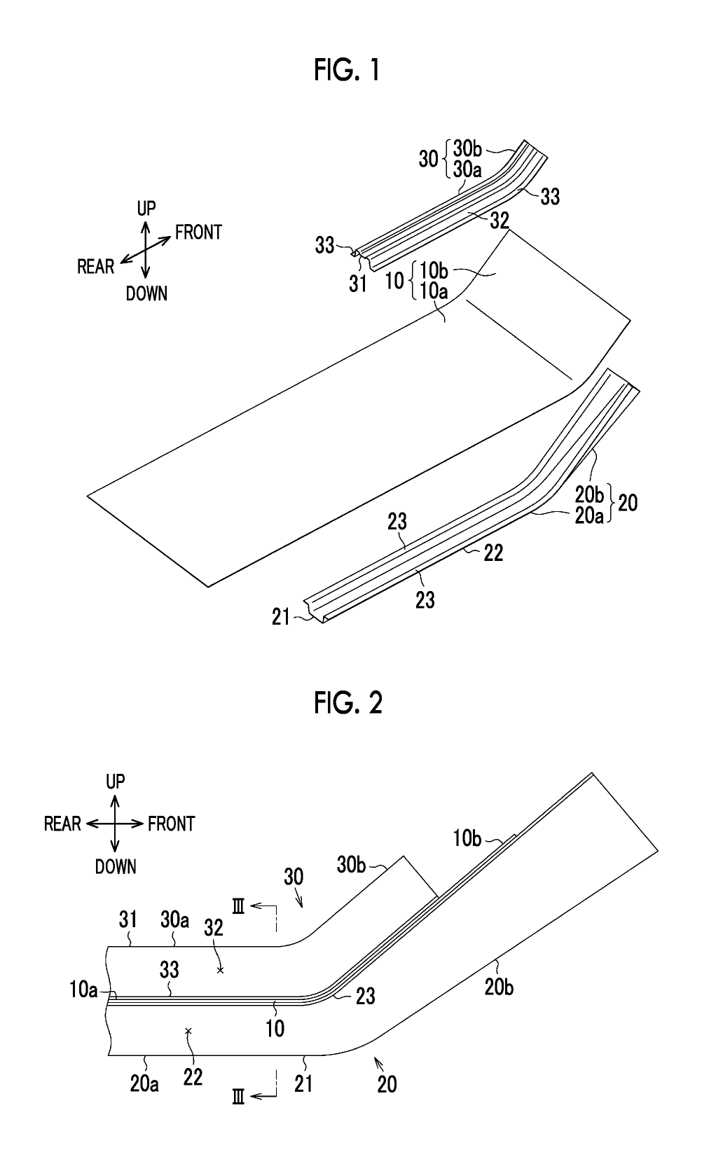

Hereinafter, an embodiment will be described with reference to FIGS. 1 to 3. As illustrated in FIG. 1, a vehicle substructure is provided with a plate-shaped floor panel 10. A rectangular panel body portion 10a and a panel front portion 10b constitute the floor panel 10. The panel body portion 10a has its length in the front-rear direction of a vehicle. The panel front portion 10b extends from the front edge of the panel body portion 10a. The panel front portion 10b is inclined such that its position becomes closer to the upper side of the vehicle as its position becomes closer to the front side of the vehicle. The panel body portion 10a and the panel front portion 10b are formed by a single plate material being bent by press working or the like.

A front side member 20 is disposed below the floor panel 10. The front side member 20 as a whole extends in the front-rear direction of the vehicle. The front side member 20 can be broadly divided into a side member body portion 20a and a side member front portion 20b. The side member body portion 20a linearly extends in the front-rear direction of the vehicle. The side member front portion 20b extends from the front edge of the side member body portion 20a. The side member front portion 20b is inclined such that its position becomes closer to the upper side of the vehicle as its position becomes closer to the front side of the vehicle. The angle of inclination of the side member front portion 20b with respect to the side member body portion 20a is equal to the angle of inclination of the panel front portion 10b of the floor panel 10 with respect to the panel body portion 10a of the floor panel 10. The dimension of the side member body portion 20a in the front-rear direction of the vehicle is shorter than the dimension of the panel body portion 10a of the floor panel 10 in the front-rear direction of the vehicle. The dimension of the side member front portion 20b in the front-rear direction of the vehicle is longer than the dimension of the panel front portion 10b of the floor panel 10 in the front-rear direction of the vehicle.

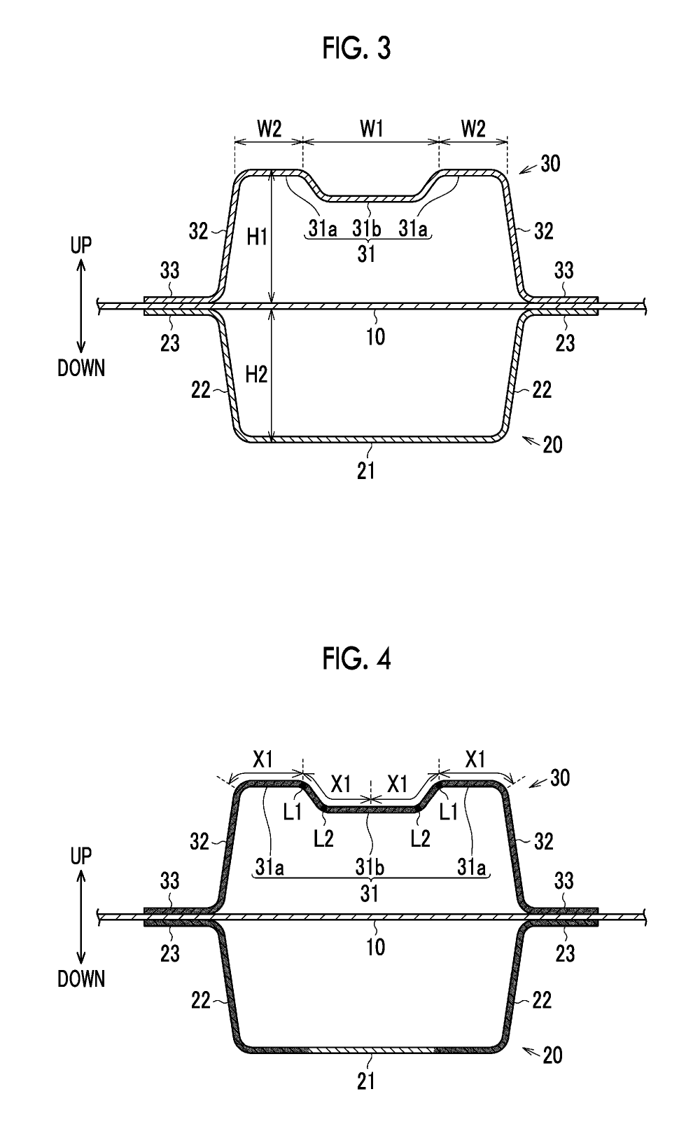

As illustrated in FIG. 3, the front side member 20 is provided with a plate-shaped lower wall portion 21 facing the floor panel 10. The lower wall portion 21 as a whole extends in the front-rear direction of the vehicle along the extension direction of the front side member 20. Specifically, the lower wall portion 21 extends in the front-rear direction of the vehicle at its part constituting the side member body portion 20a and is inclined such that its position becomes closer to the upper side of the vehicle as its position becomes closer to the front side of the vehicle, at its part constituting the side member front portion 20b as illustrated in FIG. 1.

As illustrated in FIG. 3, a side wall portion 22 extends upward (to the floor panel 10 side) from each outer edge of the lower wall portion 21 in the width direction of the vehicle (right-left direction in FIG. 3). As illustrated in FIG. 2, the length of extension of each side wall portion 22 from the lower wall portion 21 is constant in the front-rear direction of the vehicle at its part constituting the side member body portion 20a. At its part constituting the side member front portion 20b, the length of extension of each side wall portion 22 from the lower wall portion 21 gradually increases as it becomes closer to the front side of the vehicle. As illustrated in FIG. 3, a flange portion 23 extends outward in the width direction of the vehicle from the upper edge of each side wall portion 22. The flange portion 23 has an upper surface fixed by welding to the lower surface of the floor panel 10.

As illustrated in FIG. 2, the front side member 20 is fixed to the floor panel 10 in a state where the boundary between the side member body portion 20a and the side member front portion 20b is aligned to correspond to the boundary between the panel body portion 10a and the panel front portion 10b of the floor panel 10. In addition, a front end side part of the side member front portion 20b of the front side member 20 protrudes more to the front side than the front end of the panel front portion 10b of the floor panel 10. Another member (not illustrated), examples of which include a dash panel and another vehicle frame structure, is fixed to the front end portion of the side member front portion 20b. The front side member 20 is formed by a single plate-shaped steel material being molded by press working or the like. A treatment such as rustproofing is performed on the surface of the front side member 20.

As illustrated in FIG. 1, an indoor reinforcement 30 is disposed above the floor panel 10. The indoor reinforcement 30 as a whole extends in the front-rear direction of the vehicle. The indoor reinforcement 30 can be broadly divided into a reinforcement body portion 30a and a reinforcement front portion 30b. The reinforcement body portion 30a linearly extends in the front-rear direction of the vehicle. The reinforcement front portion 30b extends from the front edge of the reinforcement body portion 30a. The reinforcement front portion 30b is inclined such that its position becomes closer to the upper side of the vehicle as its position becomes closer to the front side of the vehicle. The angle of inclination of the reinforcement front portion 30b with respect to the reinforcement body portion 30a is equal to the angle of inclination of the panel front portion 10b of the floor panel 10 with respect to the panel body portion 10a of the floor panel 10. The dimension of the reinforcement body portion 30a in the front-rear direction of the vehicle is shorter than the dimension of the panel body portion 10a of the floor panel 10 in the front-rear direction of the vehicle. The dimension of the reinforcement front portion 30b in the front-rear direction of the vehicle is shorter than the dimension of the panel front portion 10b of the floor panel 10 in the front-rear direction of the vehicle.

As illustrated in FIG. 3, the indoor reinforcement 30 is provided with an upper wall portion 31 facing the floor panel 10. The upper wall portion 31 as a whole extends in the front-rear direction of the vehicle along the extension direction of the front side member 20. Specifically, the upper wall portion 31 extends in the front-rear direction of the vehicle at its part constituting the reinforcement body portion 30a and is inclined such that its position becomes closer to the upper side of the vehicle as its position becomes closer to the front side of the vehicle, at its part constituting the reinforcement front portion 30b as illustrated in FIG. 1. The dimension of the upper wall portion 31 in the width direction of the vehicle is equal to the dimension of the lower wall portion 21 of the front side member 20 in the width direction of the vehicle.

As illustrated in FIG. 3, a side wall portion 32 extends downward (to the floor panel 10 side) from each outer edge of the upper wall portion 31 in the width direction of the vehicle. As illustrated in FIG. 2, the length of extension of each side wall portion 32 from the upper wall portion 31 is constant over the entire extension direction of the upper wall portion 31. As illustrated in FIG. 3, a flange portion 33 extends outward in the width direction of the vehicle from the lower edge of each side wall portion 32. The flange portion 33 is disposed to face the flange portion 23 of the front side member 20 across the floor panel 10. The flange portion 33 has a lower surface fixed by welding to the upper surface of the floor panel 10.

As illustrated in FIG. 2, the indoor reinforcement 30 is fixed to the floor panel 10 in a state where the boundary between the reinforcement body portion 30a and the reinforcement front portion 30b is aligned to correspond to the boundary between the panel body portion 10a and the panel front portion 10b of the floor panel 10. In addition, the front end of the reinforcement front portion 30b of the indoor reinforcement 30 is positioned behind the front end of the panel front portion 10b of the floor panel 10. In other words, the front end of the indoor reinforcement 30 does not reach the front end of the floor panel 10.

The part that the side member front portion 20b of the front side member 20, the panel front portion 10b of the floor panel 10, and the reinforcement front portion 30b of the indoor reinforcement 30 constitute is sometimes referred to as a kick portion (kick-up portion) of the vehicle substructure.

As illustrated in FIG. 3, the upper wall portion 31 of the indoor reinforcement 30 is provided with flat plate-shaped flat portions 31a and a ridge portion 31b that protrudes from the flat portions 31a toward the lower side of the vehicle (to the floor panel 10 side). The ridge portion 31b is positioned in the middle portion of the upper wall portion 31 in the width direction of the vehicle. In cross-sectional view, the ridge portion 31b has the shape of a trapezoid that has its short side on the lower side of the vehicle. In addition, the ridge portion 31b is disposed over the entire upper wall portion 31 in the front-rear direction of the vehicle. In other words, the ridge portion 31b is disposed in the upper wall portion 31 in the reinforcement front portion 30b as well. The flat portions 31a are positioned on both sides of the ridge portion 31b in the width direction of the vehicle. Each flat portion 31a is parallel to the floor panel 10. The flat portions 31a are positioned on the same plane. The upper edges of the side wall portions 32 are connected to the respective outer sides of the flat portions 31a in the width direction of the vehicle.

A dimension W1 of the ridge portion 31b in the width direction of the vehicle is half of the dimension of the upper wall portion 31 as a whole in the width direction of the vehicle. Dimensions W2 of the flat portions 31a in the width direction of the vehicle are equal to each other. The dimension W2 is a quarter of the dimension of the upper wall portion 31 as a whole in the width direction of the vehicle. The indoor reinforcement 30 is formed by a steel material being molded by press working or the like. The steel material is identical to the steel material that is used as the front side member 20. The plate thicknesses of two steel materials are equal to each other.

The vehicle substructure according to the embodiment has a part where a distance H1 is equal to or longer than a distance H2. The distance H1 is the distance from the upper surface of the floor panel 10 to the upper surface of the flat portion 31a of the indoor reinforcement 30. The distance H2 is the distance from the lower surface of the floor panel 10 to the lower surface of the lower wall portion 21 of the front side member 20. Specifically, the distance H1 from the upper surface of the floor panel 10 to the upper surface of the flat portion 31a of the indoor reinforcement 30 is equal to the distance H2 from the lower surface of the floor panel 10 to the lower surface of the lower wall portion 21 of the front side member 20 (the distance H1 is equal to or longer than the distance H2) at the body part of the vehicle substructure according to the embodiment that the panel body portion 10a, the side member body portion 20a, and the reinforcement body portion 30a constitute, that is, at the part that is not the kick portion.

A floor tunnel portion (not illustrated) is disposed on one side of the floor panel 10 in the width direction of the vehicle. A floor panel, a front side member, and an indoor reinforcement are also disposed on the opposite side of the floor panel 10 across the floor tunnel portion. The opposite side of the floor panel 10 across the floor tunnel portion is identical in configuration to the vehicle substructure described above.

The action and effect of the vehicle substructure configured as described above will be described below. In a case where a load acts on the vehicle substructure according to the embodiment from the front side of the vehicle, deformation can occur in the form of, for example, bending of the indoor reinforcement 30. Flexural rigidity with respect to the bending is hardly improved simply with an increase in the width of the flat plate-shaped part. The flexural rigidity is increasingly improved as the part that is positioned within a predetermined range from a ridgeline extending in the front-rear direction of the vehicle increases in a case where the vehicle substructure is viewed in cross section on a plane orthogonal to the front-rear direction of the vehicle.

As illustrated in FIG. 4, the upper wall portion 31 of the indoor reinforcement 30 is provided with the ridge portion 31b in the vehicle substructure according to the embodiment. Accordingly, at least two ridgelines L1 formed at the boundaries between the ridge portion 31b and the flat portions 31a increase compared to, for example, a case where the upper wall portion 31 is made up of a single flat portion 31a. Therefore, according to the embodiment, deformation is less likely to occur with respect to a load from the front-rear direction of the vehicle than in the case where the upper wall portion 31 of the indoor reinforcement 30 is made up of the single flat portion 31a. As a result, the load can be effectively borne.

The parts that are within the range of a predetermined distance X1 from the ridgelines L1 significantly contribute to improving the flexural rigidity of the upper wall portion 31 of the indoor reinforcement 30 with respect to the load from the front-rear direction of the vehicle. The predetermined distance X1 is determined based on the plate thickness of the upper wall portion 31, the material that constitutes the upper wall portion 31, and so on. For example, the predetermined distance X1 is increased as the plate thickness is increased. According to the embodiment, in the upper wall portion 31, the dimension W1 of the ridge portion 31b in the width direction of the vehicle is half of the dimension of the upper wall portion 31 as a whole in the width direction of the vehicle and the dimension W2 of each flat portion 31a in the width direction of the vehicle is a quarter of the dimension of the upper wall portion 31 as a whole in the width direction of the vehicle. Accordingly, the entire upper wall portion 31 can be kept within the range of the predetermined distance X1 from the ridgeline L1 insofar as the distance from the ridgeline L1 of the upper wall portion 31 of the indoor reinforcement 30 to the middle of the ridge portion 31b in the width direction of the vehicle along the shape of the ridge portion 31b can be ensured as the predetermined distance X1 as illustrated in FIG. 4. As a result, needed rigidity is ensured with greater ease as the flexural rigidity with respect to the load from the front-rear direction of the vehicle even when a hard material is adopted as the material of the upper wall portion 31 (indoor reinforcement 30) or the plate thickness is increased.

In the embodiment, in particular, the ridge portion 31b is trapezoidal in shape in cross-sectional view, and thus two ridgelines L2 are formed on the protruding tip sides of the ridge portion 31b (sides on the short side of the trapezoidal shape in cross-sectional view) as well. Accordingly, the entire ridge portion 31b is kept within the range of the predetermined distance X1 from the ridgeline L2 insofar as at least a quarter of the dimension of the upper wall portion 31 as a whole in the width direction of the vehicle can be ensured as the predetermined distance X1. In the embodiment, the dimension of the flat portion 31a in the width direction of the vehicle is a quarter of the dimension of the upper wall portion 31 as a whole, and thus the entire flat portion 31a is kept within the range of the predetermined distance X1 from the ridgeline L1 insofar as a quarter of the dimension of the upper wall portion 31 as a whole in the width direction of the vehicle can be ensured as the predetermined distance X1 as described above. The entire upper wall portion 31 can be kept within the range of the predetermined distance X1 from the ridgeline L1 and the ridgeline L2 insofar as a quarter of the dimension of the upper wall portion 31 as a whole in the width direction of the vehicle can be ensured as the predetermined distance X1 as described above. Accordingly, sufficient rigidity is ensured with ease as the flexural rigidity of the upper wall portion 31 even without the plate thickness of the upper wall portion 31 (indoor reinforcement 30) being excessively increased for an increase in the predetermined distance from the ridgeline.

In the vehicle substructure according to the embodiment, ridgelines are formed at the boundary between the upper wall portion 31 and each side wall portion 32 and the boundary between each side wall portion 32 and the flange portion 33 in addition to the ridgeline L1 and the ridgeline L2 of the upper wall portion 31 of the indoor reinforcement 30. Likewise, in the front side member 20, ridgelines are formed at the boundary between the lower wall portion 21 and each side wall portion 22 and the boundary between each side wall portion 22 and the flange portion 23. In FIG. 4, the distance from the ridgeline L1 to the middle of the ridge portion 31b in the width direction of the vehicle along the shape of the ridge portion 31b is assumed as the predetermined distance X1 and the part within the range of the predetermined distance X1 from each of the ridgelines including the ridgeline L1 and the ridgeline L2 is illustrated in a colored form.

The front side member 20 disposed below the floor panel 10 in the vehicle is likely to be exposed to wind and rain. Accordingly, a surface treatment such as rustproofing is performed in some cases for deterioration to be prevented. Depending on the type of the surface treatment, the strength of the front side member 20 is declined after the surface treatment. In addition, even after the surface treatment is performed, the front side member 20 is subjected to some extent to deterioration attributable to its exposure to wind and rain. The indoor reinforcement 30 disposed above the floor panel 10 is relatively less likely to be exposed to wind and rain, and thus the indoor reinforcement 30 is less likely to be subjected to deterioration attributable to wind and rain. In addition, a surface treatment such as rustproofing is optional for the indoor reinforcement 30 and the indoor reinforcement 30 is relatively less likely to undergo a decline in strength attributable to a surface treatment.

The distance H1 from the upper surface of the floor panel 10 to the upper surface of the flat portion 31a of the indoor reinforcement 30 is equal to the distance H2 from the lower surface of the floor panel 10 to the lower surface of the lower wall portion 21 of the front side member 20 at the body part of the vehicle substructure according to the embodiment that the panel body portion 10a, the side member body portion 20a, and the reinforcement body portion 30a constitute (at the part that is not the kick portion). Accordingly, even if the vehicle substructure undergoes a decline in strength attributable to a surface treatment and deterioration attributable to its exposure to wind and rain, the occurrence of the decline in strength and the deterioration described above can be limited to the lower half of the vehicle substructure as a whole. In the upper half of the vehicle substructure as a whole, its strength can be maintained in a state where the decline in strength and the deterioration are relatively less likely to occur, and thus a decline in the strength of the vehicle substructure can be minimized.

In a case where the height position of the lower wall portion 21 of the front side member 20 is fixed in the up-down direction of the vehicle, the height position of the floor panel 10 becomes closer to the upper side as the distance H2 from the lower surface of the floor panel 10 to the lower surface of the lower wall portion 21 of the front side member 20 increases. Once the floor panel 10 is disposed to be closer to the upper side as described above, the gap between the floor panel 10 and the flooring material (carpet material) of the vehicle cabin becomes narrower than it usually is. Then, the thickness of the sound absorbing material therebetween in the up-down direction of the vehicle may become smaller than it usually is and the quietness in the vehicle cabin may be reduced. In the embodiment, the distance H2 from the lower surface of the floor panel 10 to the lower surface of the lower wall portion 21 of the front side member 20 is approximately half of the height dimension of the vehicle substructure as a whole and is relatively short in this regard. Accordingly, a situation rarely occurs in which the floor panel 10 is disposed to be excessively closer to the upper side and a sufficient thickness cannot be ensured as the thickness of the sound absorbing material.

A power unit such as an internal combustion engine is disposed in front of the kick portion of the vehicle substructure. Accordingly, when sound insulation is insufficient in the kick portion, noise from the power unit may be transmitted into the vehicle cabin. In a case where the dimension of the kick portion of the vehicle substructure in the up-down direction remains unchanged, the panel front portion 10b is positioned on the obliquely upper rear side of the vehicle and the distance to the flooring material of the vehicle cabin becomes relatively short once, for example, the indoor reinforcement 30 is configured to have a flat plate shape and a shape curved such that its middle portion in the width direction of the vehicle protrudes downward.

When the above-described configurations related to the upper wall portion 31, the side wall portion 32, and the flange portion 33 are applied to the reinforcement front portion 30b of the indoor reinforcement 30 as in the configuration described above, in contrast, the panel front portion 10b can be positioned on the obliquely lower front side of the vehicle compared to, for example, the case where the indoor reinforcement 30 is configured to have the flat plate shape and the shape curved such that its middle portion in the width direction of the vehicle protrudes downward. Accordingly, the distance from the panel front portion 10b to the flooring material of the vehicle cabin above the panel front portion 10b can be increased and the space therebetween is capable of functioning as a sound insulation space for sound absorbing material disposition. As a result, noise transmission from the power unit into the vehicle cabin can be further suppressed.

The embodiment can be modified as follows.

The relationship between the distance H1 from the upper surface of the floor panel 10 to the upper surface of the flat portion 31a of the indoor reinforcement 30 and the distance H2 from the lower surface of the floor panel 10 to the lower surface of the lower wall portion 21 of the front side member 20 is not limited to the example according to the embodiment described above. For example, the distance H1 from the upper surface of the floor panel 10 to the upper surface of the flat portion 31a of the indoor reinforcement 30 may be longer than the distance H2 from the lower surface of the floor panel 10 to the lower surface of the lower wall portion 21 of the front side member 20. According to this configuration, the proportion occupied by the indoor reinforcement 30 that is likely to maintain its strength in a state where a decline in strength and deterioration are relatively less likely to occur in the up-down direction of the vehicle can become relatively higher.

The distance H1 from the upper surface of the floor panel 10 to the upper surface of the flat portion 31a of the indoor reinforcement 30 may be shorter than the distance H2 from the lower surface of the floor panel 10 to the lower surface of the lower wall portion 21 of the front side member 20 insofar as the impact of a decline in strength attributable to a surface treatment and deterioration attributable to exposure to wind and rain is relatively small on the front side member 20.

The relationship between the distance H1 and the distance H2 may also be applied to the kick portion that the panel front portion 10b, the side member front portion 20b, and the reinforcement front portion 30b constitute. In other words, the distance H1 from the upper surface of the floor panel 10 to the upper surface of the flat portion 31a of the indoor reinforcement 30 may be equal to or longer than the distance H2 from the lower surface of the floor panel 10 to the lower surface of the lower wall portion 21 of the front side member 20 in the kick portion of the vehicle substructure.

The plate material that constitutes the front side member 20 and the plate material that constitutes the indoor reinforcement 30 may differ from each other in material and plate thickness. The materials and the plate thicknesses may be appropriately changed in view of, for example, the load that is expected to act on the front side member 20 and the load that is expected to act on the indoor reinforcement 30.

The position of the ridge portion 31b in the width direction of the vehicle in the upper wall portion 31 of the indoor reinforcement 30 is not limited to the middle portion of the upper wall portion 31 in the width direction of the vehicle. The ridge portion 31b may also be disposed close to the outer side or inner side of the upper wall portion 31 in the width direction of the vehicle.

The dimension of the ridge portion 31b of the upper wall portion 31 in the width direction of the vehicle is not limited to the example according to the embodiment described above. When the dimension of the ridge portion 31b in the width direction of the vehicle is less than one-third of the dimension of the upper wall portion 31 as a whole in the width direction of the vehicle, for example, the dimension of the flat portion 31a in the width direction of the vehicle increases, and thus the flat portion 31a becomes less likely to be kept within the range of the predetermined distance X1 from the ridgeline L1 and the ridgeline L2 to the same extent. When the dimension of the ridge portion 31b in the width direction of the vehicle exceeds two-thirds of the dimension of the upper wall portion 31 as a whole in the width direction of the vehicle, the dimension of the flat part in the width direction of the vehicle increases depending on the shape of the ridge portion 31b, and thus the flat portion 31a becomes less likely to be kept within the range of the predetermined distance X1 from the ridgeline L1 and the ridgeline L2 to the same extent. Accordingly, it is preferable that the dimension of the ridge portion 31b in the width direction of the vehicle has an approximate range of one-third to two-thirds of the dimension of the upper wall portion 31 as a whole in the width direction of the vehicle for the upper wall portion 31 as a whole to be kept within the range of the predetermined distance X1 from the ridgeline L1 and the ridgeline L2 with an excessive increase in the plate thickness of the upper wall portion 31 further suppressed.

A hard material can be adopted as the material of the upper wall portion 31 (indoor reinforcement 30) and a correspondingly large plate thickness can be adopted. Any dimension can be given to the ridge portion 31b in the width direction of the vehicle insofar as a sufficient distance can be ensured as the predetermined distance X1 as a result of the adoption. Even in this case, the flexural rigidity of the upper wall portion 31 with respect to a load in the front-rear direction of the vehicle is improved, compared to a case where the ridge portion 31b is not disposed, insofar as the ridge portion 31b is disposed.

A plurality of the ridge portions 31b can be disposed in the upper wall portion 31 as well. When the ridge portions 31b are disposed, the number of the ridgelines extending in the front-rear direction of the vehicle increases to the same extent. Accordingly, the strength of the upper wall portion 31 can be further improved.

The shape of the ridge portion 31b in cross-sectional view is not limited to the trapezoidal shape. For example, the shape of the ridge portion 31b in cross-sectional view may be the shape of a triangle protruding toward the lower side of the vehicle or may be the shape of an arc-shaped curve protruding toward the lower side of the vehicle. As in a case where the ridge portion 31b is curved in an arc shape in cross-sectional view or the like, no ridgeline (corresponding to the ridgeline L2 in the example of the embodiment described above) is formed in the ridge portion 31b in some cases, although the ridgeline L1 is formed at the boundary between the ridge portion 31b and the flat portion 31a, depending on the shape of the ridge portion 31b.

The ridge portion 31b may also protrude toward the upper side of the vehicle with respect to the flat portion 31a. Effects similar to those of the embodiment described above can still be achieved even when the ridge portion 31b protrudes toward the upper side of the vehicle.

A ridge portion protruding toward the upper side of the vehicle or the lower side of the vehicle and extending in the front-rear direction of the vehicle may be disposed in the lower wall portion 21 of the front side member 20. By the ridge portion being disposed as described above, the ridgeline extending in the front-rear direction of the vehicle in the lower wall portion 21 increases. Then, the flexural rigidity with respect to the load in the front-rear direction of the vehicle can be improved.

The dimensional relationship that the panel front portion 10b of the floor panel 10, the side member front portion 20b of the front side member 20, and the reinforcement front portion 30b of the indoor reinforcement 30 have in the front-rear direction of the vehicle is not limited to the example according to the embodiment described above. The dimensional relationship may be appropriately set in view of, for example, the shape of another member attached to the members.

What is claimed is:

1. A vehicle substructure comprising:
a floor panel;
a front side member disposed below the floor panel and extending in a front-rear direction of a vehicle; and
an indoor reinforcement disposed above the floor panel and extending in the front-rear direction of the vehicle, the indoor reinforcement being disposed on an opposite side of the floor panel to the front side member, wherein:
the indoor reinforcement includes
an upper wall portion facing the floor panel and extending in the front-rear direction of the vehicle,
a pair of side wall portions extending downward from respective outer edges on both sides of the upper wall portion in a width direction of the vehicle, and
a pair of flange portions extending outwards from lower edges of respective side wall portions, lower surfaces of the flange portions being fixed to an upper surface of the floor panel; and
the upper wall portion has
flat plate-shaped flat portions, and
a ridge portion protruding from the flat portions toward an upper side of the vehicle or a lower side of the vehicle and extending in the front-rear direction of the vehicle.

2. The vehicle substructure according to claim 1, wherein:
the upper wall portion includes
the ridge portion positioned in a middle portion of the upper wall portion in the width direction of the vehicle, and
the flat portions positioned on both sides of the ridge portion in the width direction of the vehicle, and
a dimension of the ridge portion in the width direction of the vehicle ranges from one-third to two-thirds of a dimension of the upper wall portion as a whole in the width direction of the vehicle.

3. The vehicle substructure according to claim 1, wherein:
the front side member includes
a plate-shaped lower wall portion facing the floor panel and extending in the front-rear direction of the vehicle,
a pair of side wall portions extending upward from respective outer edges of the lower wall portion in the width direction of the vehicle, and
a pair of flange portions extending outwards from upper edges of respective side wall portions, upper surfaces of the flange portions being fixed to a lower surface of the floor panel; and
the indoor reinforcement and the front side member are formed of the same material to have the same plate thickness, and a distance from the upper surface of the floor panel to an upper surface of the flat portion of the indoor reinforcement is equal to or longer than a distance from the lower surface of the floor panel to a lower surface of the lower wall portion of the front side member at at least a part of the indoor reinforcement and the front side member in the front-rear direction of the vehicle.

4. The vehicle substructure according to claim 1, wherein:
the front side member includes a side member body portion and a side member front portion disposed ahead of the side member body portion in the front-rear direction of the vehicle and inclined such that a position of the side member front portion becomes closer to the upper side as the position of the side member front portion becomes closer to a front side of the vehicle;
the floor panel includes a panel body portion and a panel front portion disposed ahead of the panel body portion in the front-rear direction of the vehicle and inclined such that a position of the panel front portion becomes closer to the upper side as the position of the panel front portion becomes closer to the front side of the vehicle;
the indoor reinforcement includes a reinforcement body portion and a reinforcement front portion disposed ahead of the reinforcement body portion in the front-rear direction of the vehicle and inclined such that a position of the reinforcement front portion becomes closer to the upper side of the vehicle as the position of the reinforcement front portion becomes closer to the front side of the vehicle;
a kick portion is configured to include the side member front portion, the panel front portion, and the reinforcement front portion; and
the upper wall portion, the side wall portions, and the flange portions of the indoor reinforcement are disposed in at least the reinforcement front portion.

5. The vehicle substructure according to claim 4, wherein the indoor reinforcement is fixed to the floor panel such that a boundary between the reinforcement body portion and the reinforcement front portion corresponds to a boundary between the panel body portion and the panel front portion of the floor panel.

6. The vehicle substructure according to claim 4, wherein a front end of the reinforcement front portion of the indoor reinforcement is positioned behind a front end of the panel front portion of the floor panel.

7. The vehicle substructure according to claim 4, wherein the front side member is fixed to the floor panel such that a boundary between the side member body portion and the side member front portion corresponds to a boundary between the panel body portion and the panel front portion of the floor panel.

8. The vehicle substructure according to claim 4, wherein a length of the side wall portion from a lower wall portion constituting the side member front portion increases toward the front side of the vehicle at a part of the side wall portion constituting the side member front portion of the front side member.

9. The vehicle substructure according to claim 4, wherein a front end side part of the side member front portion of the front side member protrudes more to the front side than a front portion of the panel front portion of the floor panel.

10. The vehicle substructure according to claim 4, wherein a length of the reinforcement body portion in the front-rear direction of the vehicle is smaller than a length of the panel body portion of the floor panel in the front-rear direction of the vehicle.

11. The vehicle substructure according to claim 4, wherein a length of the reinforcement front portion in the front-rear direction of the vehicle is smaller than a length of the panel front portion of the floor panel in the front-rear direction of the vehicle.
